(19) United States
(12) Patent Application Publication
(10) Pub. No.: US 2006/0171713 A1
(43) Pub. Date: Aug. 3, 2006

(54) Optical channel assigning system and method of assigning data to optical channels in optical network

(75) Inventor: Fei fei Feng, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/341,442

(22) Filed: Jan. 30, 2006

(30) Foreign Application Priority Data
Feb. 2, 2005 (KR) 10-2005-0009438

(51) Int. Cl. H04J 14/00

(52) U.S. Cl. 398/69; 370/468

(57) ABSTRACT

An optical channel assigning system in an optical network including a source node, a destination node, and a network controller for controlling transmission of data through a plurality of optical channels that connect the source node and the destination node to each other and a method of assigning data to the optical channels. The network controller assigns the data to the optical channels in the order in which the transmission information of the data is received from at least one user before a predetermined time from the transmission starting time of the data and, when a region capable of being assigned following data is not secured in the optical channels, at least one of dividing the following data into regions to assign to the plurality of optical channels and of tuning the optical channels again to re-assign the data items to the optical channels is performed. When the data is assigned to the optical channels, users can make reservations for use of the optical channels and blocking probability is reduced.

This application claims priority from Korean Patent Application No. 10-2005-0009438, filed on Feb. 2, 2005 the entire content of which is incorporated herein by reference.

### BACKGROUND OF THE INVENTION

1. Field of the Invention

Apparatuses and methods consistent with the present invention relate to assigning data to optical channels in an optical network, and more particularly to assigning data to optical channels in an optical network in which data are assigned to optical channels in consideration of the order in which reservations are made by users and the transmission order of data so that it is possible to reduce probability of rejecting the assignment of following data to optical channels.

2. Description of the Related Art

In optical communications, data items are loaded on a laser so that the data items can be transmitted through optical fiber. Recently, as a wavelength division multiplexing (WDM) transmission technology of transmitting a plurality of data items having different wavelengths by one optical fiber has been developed, transmission capacity has increased. Therefore, it is possible to cope with transmission traffic caused by tremendous increase in demand.

According to the WDM, since optical channels are set and disassembled in a dynamic way, a dynamic routing and wavelength assignment (DRWA) method is used. According to the DRWA method, when transmission of data through an optical path is requested by a user, a network controller for controlling an optical network executes a DRWA algorithm so that a proper route for the request of the user is searched so as not to affect data on existent optical channels and the requested data items are assigned to optical channels. A method in which DRWA is performed at the same time where a request by the user is generated is referred to as an immediate reservation (IR) method. However, in the actual network, a user can preserve transmission of data. Therefore, DRWA of an advance reservation (AR) method is proposed. When AR DRWA is used, the user can transmit data at a desired time and, when transmission of data cannot be performed at a desired time, the user can change the time at which data may be properly transmitted.

However, the AR DRWA can cause the following problems due to inconsistency between the order in which a plurality of users make reservations on the transmission of data and the time at which transmission of data starts.

As illustrated in FIG. 1, when the AR DRWA is requested, the user must specify a source node, a destination node, a data transmission starting time, and a data transmission completion time. Here, the source node is a node from which data is transmitted and the destination node is a node to which data is received.

As illustrated in FIG. 2, it is assumed that a plurality of users make reservations on transmission of data L1, L2, L3, and L4 at 1, 2, 3, and 4 seconds and that the transmission starting times and the transmission completion times of the data are 10.0 seconds and 13.0 seconds in the case of L1, 15.0 seconds and 18.0 seconds in the case of L2, 11.5 seconds and 14.5 seconds in the case of L3, and 14.0 seconds and 17.0 seconds in the case of L4. Here, while the users make reservations in the order of L1, L2, L3, and L4, transmission is performed in the order of L1, L3, L4, and L2 in accordance with the transmission starting time. The network controller assigns data items to optical channels in the order in which reservations are made. When data items are assigned to optical channels in the order in which reservations are made, a proper number of data items are assigned to one optical channel and then, transmission of data is assigned to another optical channel. Therefore, the network controller first assigns the data L1 to the optical channel λ₁ so that transmission starts at 10.0 seconds and assigns the data L2 to the optical channel λ₁ that is the same optical channel to which the data L1 is assigned so that transmission starts at 15.0 seconds. Next, the data L3 is to be assigned to an optical channel. At this time, since the transmission starting time of the data L3 is 11.5 seconds, the data L3 cannot be assigned to the optical channel λ₁. Therefore, the network controller assigns the data L3 to the optical channel 2. Finally, the data L4 is to be assigned. When the data L4 is assigned to the optical channel λ₂ that is the same optical channel to which the data L3 is assigned, the transmission starting time of the data L4, which is 14.0 seconds, is included in the transmission period of the data L3. When the data L4 is assigned to the optical channel λ₁, the transmission period of the data L4 overlaps the transmission period of the data L2. Therefore, the data L4 cannot be transmitted at the time when the user makes a reservation.

As described above, when the optical channels are assigned using the conventional AR DRWA method, since the order in which reservations are made with respect to the transmission of data is different from the order in which transmission of data is performed in accordance with the transmission starting time of data, there exists data whose transmission is rejected such as the data L4. Therefore, a method of assigning optical channels in consideration of the transmission order is proposed so as to prevent the generation of the data whose transmission is rejected such as the data L4.

### SUMMARY OF THE INVENTION

The present invention provides an optical channel assigning system and a method of assigning data to optical channels in which data items are assigned to optical channels in consideration of the order in which reservations are made by users and the transmission order of data so that it is possible to reduce probability of rejecting the assignment of following data to optical channels.

According to an aspect of the present invention, there is provided an optical channel assigning system in an optical network comprising a source node from which transmission of data starts, a destination node to which data from the source node is received, and a network controller for controlling transmission of data through a plurality of optical channels that connect the source node and the destination node to each other. The network controller assigns the data to the optical channels in the order where the transmission information of the data is received from at least one user before a predetermined time from the transmission starting time of the data and, the following data is divided into at least two regions to assign the divided regions to the plurality of optical channels when a region capable of being assigned following data is not secured in the optical channels.

When the following data is divided, the network controller may search an optical channel having an as long as possible period from the starting region of the following data to assign at least a part of the front region of the following data.

During the division of the following data, when the other optical channel capable of being assigned the remaining region excluding the front region exists, the network controller may assign at least a part of the remaining region of the following data to the other optical channel.

When the following data is divided, the network controller may assign the data to the optical channels so that the end of the front region assigned to the optical channel overlaps the head of the remaining part assigned to the other optical channel by a predetermined period.

According to another aspect of the present invention, there is provided an optical channel assigning system in an optical network comprising a source node from which transmission of data starts, a destination node to which data from the source node is received, and a network controller for controlling transmission of data through a plurality of optical channels that connect the source node and the destination node to each other. The network controller assigns the data to the optical channels in the order where the transmission information of the data is received from at least one user before a predetermined time from the transmission starting time of the data. When a region capable of being assigned following data is not secured in the optical channels, the optical channels are tuned again to re-assign the data items including the following data to the optical channels.

Here, when the data items are re-assigned to the optical channels, the network controller may transmit at least one of the preceding data whose transmission period is similar to the transmission period of the following data to the other optical channel and transmits the following data to the optical channel to which the preceding data was assigned.

According to another aspect of the present invention, there is provided an optical channel assigning system in an optical network comprising a source node from which transmission of data starts, a destination node to which data from the source node is received, and a network controller for controlling transmission of data through a plurality of optical channels that connect the source node and the destination node to each other. The network controller assigns the data to the optical channels in the order in which the transmission information of the data is received from at least one user before a predetermined time from the transmission starting time of the data. When a region capable of being assigned following data is not secured in the optical channels, at least one of the method of dividing the following data into at least two regions to assign the divided regions to the plurality of optical channels and the method of tuning the optical channels again to re-assign the data items including the following data to the optical channels is performed.

According to another aspect of the present invention, there is provided a method of assigning data to optical channels in an optical network having a source node from which transmission of data starts and a destination node to which data from the source node is received, the method comprising the steps of receiving transmission information on data transmitted from the source node to the destination node from at least one user before a predetermined time from the transmission starting time, assigning the data items to the optical channels, respectively, in the order in which reservations on transmission information are made by the users, and when a region capable of being assigned following data among the data items is not secured in the optical channels, performing at least one of the step of dividing the following data into at least two regions to assign the divided regions to the plurality of optical channels and the step of tuning the optical channels again to re-assign the data items including the following data to the optical channels.

### BRIEF DESCRIPTION OF THE DRAWINGS

The above and/or other aspects of the present invention will be more apparent by describing exemplary embodiments of the present invention with reference to the accompanying drawings, in which:

FIG. 1 is a diagram of a conventional optical channel assignment system;

FIG. 2 is a chart illustrating the transmission times of data for ordered reservations;

FIG. 3 is a diagram of an optical channel assignment system according to an exemplary embodiment of the present invention;

FIG. 4 is a diagram of an optical channel assignment system according to another exemplary embodiment of the present invention;

FIG. 5 is a graph illustrating a comparison of blocking probabilities as a function of a load;

FIG. 6 is a graph illustrating a comparison of blocking probabilities as a function of book-ahead time and load; and

FIG. 7 is a flow chart illustrating a method of assigning data to optical channels according to another exemplary embodiment of the present invention.

### DETAILED DESCRIPTION OF EXEMPLARY EMBODIMENTS

Exemplary embodiments of the present invention will be described in greater detail with reference to the accompanying drawings.

An optical channel scheduling method in dynamic routing and wavelength assignment (DRWA) can be applied to all of the source nodes that can transmit data on an optical network and can be executed by a network controller for controlling the entire optical network or a node controller for controlling the nodes. The network controller will be taken as an example in the embodiments to be mentioned later for the sake of convenience.

In general, the optical network includes a source node from which data is transmitted and a destination node to which data is received and may further include an intermediate node for connecting the source node and the destination node. A plurality of optical channels having different wavelengths is formed between the source node and the destination node. The optical network includes a network controller for setting the optical channels of optical signals that move along the source node, the destination node, and the intermediate node and for controlling the operations of the nodes.

A method of assigning data to the optical channels by the AR-DRWA of segmentation-reassignment (SR) in which data items are assigned to the optical channels in the order in which reservations are made by users and in the order of transmission of data in the optical network will be described as follows.

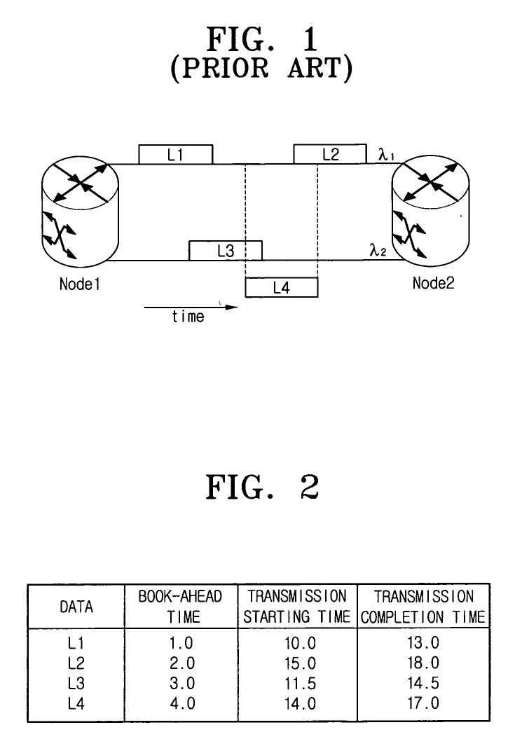

As illustrated in FIG. 2, it is assumed that a plurality of users make reservations on transmission of data L1, L2, L3, and L4 at 1, 2, 3, and 4 seconds respectively, and that the transmission starting times and the transmission completion times of the data are as follows. The transmission starting time ts and the transmission completion time td of the data L1 are 10.0 seconds and 13.0 seconds. The transmission starting time and the transmission completion time of the data L2 are 15.0 seconds and 18.0 seconds. The transmission starting time and the transmission completion time of the data L3 are 11.5 seconds and 14.5 seconds. The transmission starting time and the transmission completion time of the data L4 are 14.0 seconds and 17.0 seconds.

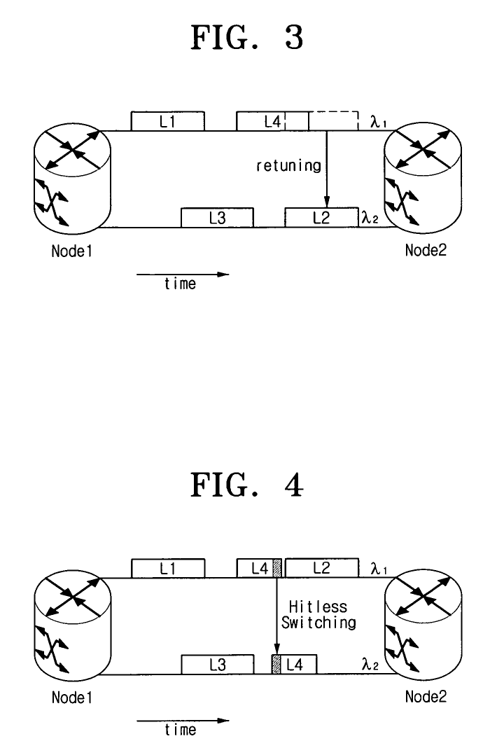

FIG. 3 illustrates that data items are assigned to the optical channels according to an exemplary embodiment of the present invention. As illustrated in FIG. 3, when the transmission starting times and the transmission completion times of the data items L1, L2, L3, and L4 transmitted from the node 1 that is the source node to the node 2 that is the destination node are input from the users, the network controller assigns the data items to the optical channels λ₁ and λ₂ that connect the node 1 and the node 2 in the order in which reservations are made.

First, the network controller assigns the data L1 to the optical channel λ₁ in the period from 10.0 seconds to 13.0 seconds, and then assigns the reserved data L2 to the optical channel λ₁ that is the same optical channel to which the data L1 is assigned in the period from 15.0 seconds to 18.0 seconds. Then, the data L3 is assigned. At this time, since the transmission starting time of the data L3 is 11.5 seconds, which is included in (overlaps) the transmission period of the data L1, the data L3 is assigned to the other optical channel λ₂ in the period from 11.5 seconds to 14.5 seconds. Finally, the data L4 is to be assigned. Since the transmission starting time of the data L4 is 14.0 seconds, which overlaps the data L3, the data L4 cannot be assigned to the optical channel λ₂. Also, since the transmission completion time of the data L4 is 17.0 seconds, the data L4 cannot be assigned to the optical channel λ₁.

Therefore, the network controller may assign data to the optical channels using the following two methods so as to be suitable for the transmission starting time and the transmission completion time on which reservations are made by users.

First, as illustrated in FIG. 3, the data items that are previously assigned are re-assigned to the optical channels. The network controller determines whether the data L4 can be assigned to the optical channel λ₁ since the data L4 cannot be assigned to the optical channel 2. At this time, since the transmission period of the data L4 overlaps the transmission period of the data L2, the network controller determines whether the data L4 can be assigned to the optical channel λ₁ when the data L2 is re-assigned to the optical channel 2. At this time, since the transmission completion time of the data L1 is 13.0 seconds, the network controller determines that the data L4 can be assigned to the optical channel λ₁ when the data L2 is re-assigned to the optical channel 2. Then, the network controller determines whether the data L2 can be assigned to the optical channel λ₂. Since the transmission completion time of the data L3 is 14.5 seconds and the transmission starting time of the data L2 is 15.0 seconds, the network controller determines that the data L2 can be re-assigned to the optical channel 2. Therefore, the network controller re-tunes the optical channels to assign the data L2 to the optical channel λ₂ and to assign the data L4 to the optical channel λ₁. The data items are assigned to the optical channels λ₁ and λ₂ by the method of re-assigning data to the optical channels so that it is possible to prevent the transmission of the data L4 from being rejected unlike in the conventional art.

Second, as illustrated in FIG. 4, the data that is likely to be rejected is divided into at least two parts to be assigned to the optical channels. The network controller determines that all of the periods of the data L4 cannot be assigned to the optical channel λ₂ and compares the data L4 with the data L3 assigned to the optical channel λ₂ to extract the period of the data L4 that can be assigned to the optical channel 2. Then, the network controller determines whether the front period of the data L4 that cannot be assigned to the optical channel λ₂ can be assigned to the optical channel λ₁.

As illustrated in FIG. 2, since the transmission starting time of the data L4 is 14.0 seconds and the transmission completion time of the data L3 is 14.5 seconds, the data L4 can be transmitted to the optical channel λ₂ after 14.5 seconds. In the case of the optical channel λ₁, since the transmission starting time of the data L2 is 15.0 seconds, when the data L4 is transmitted to the optical channel λ₁, the data L4 can be transmitted to the optical channel λ₁ from 14.0 seconds to 15.0 seconds, which is the transmission starting time of the data L4. Therefore, the front period of the data L4 can be transmitted to the optical channel λ₁ and the rear period of the data L4 can be transmitted to the optical channel 2.

The network controller switches the data L4 from the optical channel λ₁ to the optical channel λ₂ at a proper time. In order to prevent data from being lost in the process of switching the optical channels, the end of the front region of the divided data overlaps the head of the rear region of the data by predetermined time. For example, the data L4 can be transmitted to the optical channel λ₁ from 14.0 seconds to 14.8 seconds and can be transmitted to the optical channel λ₂ from 14.7 seconds to 17.0 seconds. Therefore, the data items L4 transmitted to the optical channels λ₁ and λ₂ overlap each other in the period from 14.7 seconds to 14.8 seconds. Among the methods of switching the optical channels while preventing data from being lost, according to exemplary embodiments of the present embodiment, a hitless switching method can be used.

According to the above-described exemplary embodiments, the optical network includes only the source node and the destination node. However, the above-described exemplary embodiments of the present invention can be applied when at least one intermediate node is provided between the source node and the destination node. The above-described exemplary embodiments of the present invention can also be applied when a plurality of, that is, more than two optical channels are provided to connect the source node and the destination node to each other.

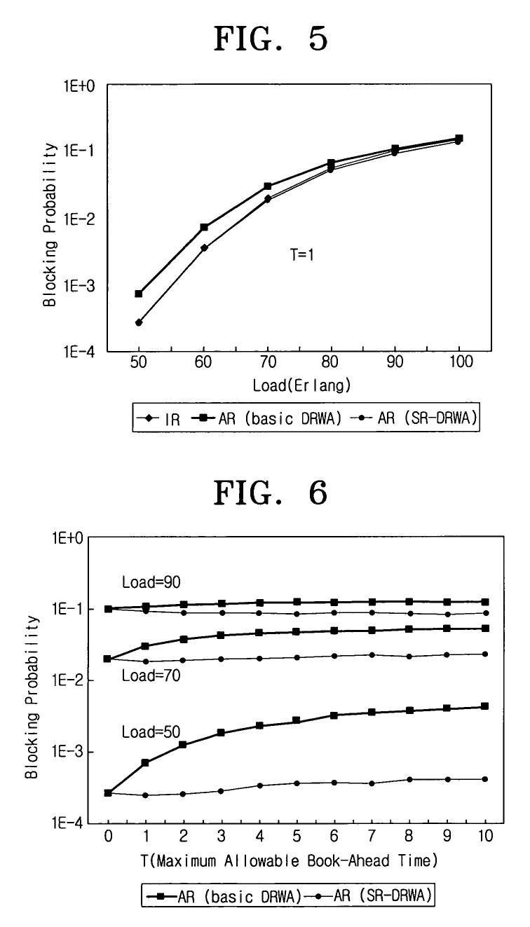

FIG. 5 is a graph showing a comparison of blocking probabilities in which the assignment of data to optical channels is rejected in the AR-DRWA of the SR method that is the method of assigning data to optical channels according to exemplary embodiments of the present invention and the conventional AR-DRWA and IR-DRWA with each other. As illustrated in FIG. 5, accordingly, as the amount, that is, load of data requested to be transmitted increases, the blocking probabilities increase. When the blocking probabilities of the DRWAs are compared with each other with respect to the load, the blocking probability of the AR-DRWA of the SR method (SR-DRWA) is much smaller than the blocking probability of the conventional AR-DRWA (basic DRWA). Therefore, it is noted that the blocking probability of the AR-DRWA of the SR method is almost the same as the blocking probability of the IR-DRWA.

FIG. 6 is a graph of comparing the blocking probabilities of the AR-DRWA and the AR-DRWA of the SR method with each other in accordance with book-ahead time and load. As illustrated in FIG. 6, when the blocking probabilities of the conventional AR-DRWA and the AR-DRWA of the SR method are compared with each other with respect to the same load, it is noted that the blocking probability of the AR-DRWA of the SR method is much smaller than the blocking probability of the conventional AR-DRWA and that the blocking probability of the AR-DRWA of the SR method is smaller than the blocking probability of the conventional AR-DRWA accordingly, as the load is smaller. Also, when the blocking probabilities in accordance with book-ahead time, that is, the distance between the time reserved by the user and the transmission starting time of data are compared with each other, in the case of the conventional AR-DRWA, when the book-ahead time increases with respect to the same load, the blocking probability increases. Meanwhile, in the case of the AR-DRWA of the SR method, almost the same blocking probability is obtained with respect to the same load regardless of the book-ahead time. Therefore, in the case of the AR-DRWA of the SR method, since the blocking probability is smaller than the blocking probability of the conventional AR-DRWA with respect to the same load and the same blocking probability is obtained regardless of increase and reduction in the book-ahead time, it is possible to secure reliability in transmission of data.

On the other hand, more than one of the above-described methods of assigning data to optical channels can be used for an optical network system. When two methods are used, the two methods are combined with each other so that one is primarily applied.

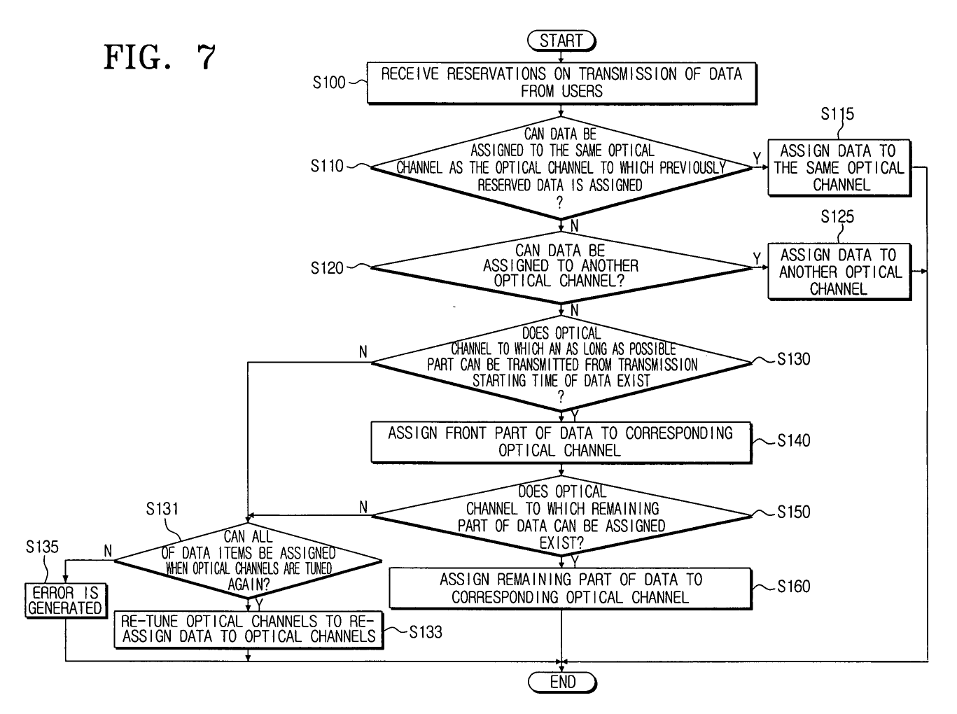

An exemplary embodiment of combining two methods of assigning data to optical channels will be described with reference to FIG. 7.

When reservations on transmission of data are input from the users (S100), the network controller determines whether data can be assigned to the optical channel that is the same optical channel to which another data is previously assigned, which is the shortest route. Using the reservation times of data as shown in FIG. 2, after the data L1 is assigned to the optical channel λ₁, when reservation on the data L2 is input from another user, the network controller assigns the data L2 to an optical channel using the shortest route. At this time, in the state where the data L1 is assigned to the optical channel λ₁, since it is the shortest route to assign the data L2 to the same optical channel λ₁, the network controller assigns the data L2 to the same optical channel λ₁.

Then, when reservation on the data L3 is input from another user, the network controller assigns the data L3 to the other optical channel λ₂ since the transmission period of the data L3 overlaps the transmission period of the data L1. Finally, when reservation on the data L4 is input from another user, the network controller determines whether a transmission period enough to assign the data L4 is secured in the optical channel λ₂ that is the shortest route (S110). When it is determined that the transmission period capable of being assigned the data L4 is secured, the network controller assigns the data L4 to the optical channel λ₂ (S115). However, as illustrated in FIG. 1, when it is determined that the transmission period capable of being assigned the data L4 is not secured in the optical channel λ₂, the network controller determines whether the transmission period enough to assign the data L4 is secured in the optical channel λ₁ (S120).

When it is determined that the transmission period capable of being assigned the data L4 is secured in the other optical channel λ₁, the network controller assigns the data L4 to the optical channel λ₁ (S125). However, when it is determined that the transmission period capable of being assigned the data L4 is not secured in the optical channel λ₁, the network controller searches the transmission period in which an as large as possible part can be transmitted from the transmission starting time of the data L4 (S130). Therefore, as illustrated in FIG. 4, the network controller transmits a front part of the data L4 to the optical channel λ₁ (S140). Then, the network controller determines whether there is a transmission period enough to transmit the remaining part of the data L4 in the other optical channel λ₂ (S150). When it is determined that there is a transmission period capable of being transmitted the remaining part of the data L4, the data L4 is assigned to the optical channel λ₂ so that the remaining part is transmitted to the optical channel λ₂ (S160).

On the other hand, when it is determined that there is no transmission period capable of being assigned the remaining part of the data L4 in the other optical channel λ₂, the network controller tunes the optical channels λ₁ and λ₂ and determines whether the data L4 can be assigned to the optical channel λ₁ (S131). First, the network controller determines whether the data L2 assigned after 14.0 seconds that is the transmission starting time of the data L4 can be assigned to the optical channel λ₂. Since the transmission completion time of the data L3 is 14.5 seconds and the transmission starting time of the data L2 is 15.0 seconds, the network controller determines that the data L2 can be re-assigned to the optical channel λ₂ and assigns the data L2 to the optical channel 2. Then, the network controller assigns the data L4 to the optical channel λ₁ (S133). At this time, when the data L2 and the data L4 cannot be re-assigned to the optical channels, transmission of the data L4 cannot be performed, and an error is generated (S135).

As described above, according to the AR-DRWA of the SR method, after data items are sequentially assigned to the optical channels in the order in which reservations are made, the data that cannot be transmitted due to the transmission period of the data overlapping the transmission period of another data is divided into at least two parts so that the divided parts are assigned to various optical channels or the optical channels are tuned to control the optical channels of the data items. Therefore, the data that could not be transmitted previously is now transmitted. When the data items are assigned to the optical channels, it is possible to make reservations on the use of the optical channels and to reduce the probability of rejecting the transmission of data, that is, the blocking probability.

The foregoing embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An optical channel assigning system in an optical network, the system comprising:
a source node from which transmission of data starts;
a destination node to which the data from the source node is received; and
a network controller which controls transmission of the data through a plurality of optical channels that couple the source node and the destination node to each other,
wherein the network controller assigns the data to the optical channels in an order in which transmission information of the data is received from at least one user by a predetermined time before a transmission starting time of the data and, if a region capable of being assigned following data is not secured in the optical channels, the following data is divided into at least two regions and the divided regions are assigned to the plurality of optical channels.

2. The optical channel assigning system as claimed in claim 1, wherein, if the following data is divided, the network controller searches for one optical channel having an as long as possible period from a starting region of the following data to assign at least a part of a front region of the following data.

3. The optical channel assigning system as claimed in claim 2, wherein, during the division of the following data, if another optical channel capable of being assigned a remaining region excluding the front region exists, the network controller assigns at least a part of the remaining region of the following data to the another optical channel.

4. The optical channel assigning system as claimed in claim 3, wherein, if the following data is divided, the network controller assigns the data to the optical channels so that an end of the front region assigned to the one optical channel overlaps a head of the remaining region assigned to the another optical channel by a predetermined period.

5. An optical channel assigning system in an optical network, the system comprising:
a source node from which transmission of data starts;
a destination node to which the data from the source node is received; and
a network controller which controls transmission of the data through a plurality of optical channels coupling the source node and the destination node to each other;
wherein the network controller assigns the data to the optical channels in an order in which the transmission information of the data is received from at least one user by a predetermined time before a transmission starting time of the data and, if a region capable of being assigned following data is not secured in the optical channels, the optical channels are tuned again to re-assign data items including the following data to the optical channels.

6. The optical channel assigning system as claimed in claim 5, wherein, if the data items are re-assigned to the optical channels, the network controller transmits at least one of a preceding data whose transmission period is similar to a transmission period of the following data to another optical channel and transmits the following data to the optical channel to which the preceding data was assigned.

7. An optical channel assigning system in an optical network, the system comprising:
a source node from which transmission of data starts;
a destination node to which the data from the source node is received; and
a network controller which controls transmission of data through a plurality of optical channels that couple the source node and the destination node to each other;
wherein the network controller assigns the data to the optical channels in an order in which the transmission information of the data is received from at least one user by a predetermined time before a transmission starting time of the data and, if a region capable of being assigned following data is not secured in the optical channels, at least one of a division of following data into at least two regions and assignment of the divided regions to the plurality of optical channels, and of tuning the optical channels again to re-assign data items including the following data to the optical channels is performed.

8. The optical channel assigning system as claimed in claim 7, wherein, if the following data is divided, the network controller searches for one optical channel having an as long as possible period from a starting region of the following data to assign at least a part of a front region of the following data.

9. The optical channel assigning system as claimed in claim 8, wherein, during the division of the following data, if another optical channel capable of being assigned a remaining region excluding the front region exists, the network controller assigns at least a part of the remaining region of the following data to the another optical channel.

10. The optical channel assigning system as claimed in claim 9, wherein, if the following data is divided, the network controller assigns the data to the optical channels so that an end of the front region assigned to the one optical channel overlaps a head of the remaining region assigned to the another optical channel by a predetermined period.

11. The optical channel assigning system as claimed in claim 7, wherein, if the data items are re-assigned to the optical channels, the network controller transmits at least one of a preceding data whose transmission period is similar to a transmission period of the following data to another optical channel and transmits the following data to the optical channel to which the preceding data was assigned.

12. A method of assigning data to optical channels in an optical network having a source node from which transmission of data starts and a destination node to which the data from the source node is received, the method comprising:
receiving transmission information on data transmitted from the source node to the destination node from at least one user by a predetermined time before a transmission starting time;
assigning data items to the optical channels, respectively, in an order in which reservations on transmission information are made by the users; and
dividing following data into at least two regions and assigning the divided regions to different optical channels if a region capable of being assigned following data from among the data items is not secured in the optical channels.

13. The method as claimed in claim 12, wherein the transmission information on the data comprises a transmission starting time and a transmission completion time of the data.

14. The method as claimed in claim 12, further comprising, if the following data is divided, searching for one optical channel having an as long as possible period from a starting region of the following data to assign at least a part of a front region of the following data.

15. The method as claimed in claim 14, further comprising, during the division of the following data, if another optical channel capable of being assigned a remaining region excluding the front region exists, assigning at least a part of the remaining region of the following data to the another optical channel.

16. The method as claimed in claim 15, further comprising, if the following data is divided, assigning the data to the optical channels so that an end of the front region assigned to the one optical channel overlaps a head of the remaining region assigned to the another optical channel by a predetermined period.

17. A method of assigning data to optical channels in an optical network having a source node from which transmission of data starts and a destination node to which the data from the source node is received, the method comprising:
receiving transmission information on data transmitted from the source node to the destination node from at least one user by a predetermined time before a transmission starting time;
assigning data items to the optical channels, respectively, in an order in which reservations on transmission information are made by the users; and
tuning the optical channels again to re-assign the data items including the following data to the optical channels if a region capable of being assigned following data from among the data items is not secured in the optical channels.

18. The method as claimed in claim 17, wherein, in the re-assigning the data items to the optical channels, at least one of a preceding data whose transmission period is similar to a transmission period of the following data is transmitted to another optical channel and the following data is transmitted to the optical channel to which the preceding data was assigned.

19. A method of assigning data to optical channels in an optical network having a source node from which transmission of data starts and a destination node to which the data from the source node is received, the method comprising:
receiving transmission information on data transmitted from the source node to the destination node from at least one user by a predetermined time before a transmission starting time;
assigning data items to the optical channels, respectively, in an order in which reservations on transmission information are made by the users; and
performing at least one of dividing following data into at least two regions and assigning the divided regions to the plurality of optical channels, and of tuning the optical channels again to re-assign data items including the following data to the optical channels if a region capable of being assigned following data from among the data items is not secured in the optical channels.

20. The method as claimed in claim 19, wherein the transmission information on the data comprises a transmission starting time and a transmission completion time of the data.

21. The method as claimed in claim 19, further comprising, if the following data is divided, searching for one optical channel having an as long as possible period from a starting region of the following data to assign at least a part of a front region of the following data.

22. The method as claimed in claim 21, further comprising, during the division of the following data, if another optical channel capable of being assigned a remaining region excluding the front region exists, assigning at least a part of the remaining region of the following data to the another optical channel.

23. The method as claimed in claim 19, further comprising, if the following data is divided, assigning the data to the optical channels so that an end of the front region assigned to the one optical channel overlaps a head of the remaining region assigned to the another optical channel by a predetermined period.

24. The method as claimed in claim 19, wherein, in the re-assigning the data items to the optical channels, at least one of a preceding data whose transmission period is similar to a transmission period of the following data is transmitted to another optical channel and the following data is transmitted to the optical channel to which the preceding data was assigned.
